(19) United States
(12) Patent Application Publication
(10) Pub. No.: US 2002/0040346 A1
(43) Pub. Date: Apr. 4, 2002

(54) Computer system and method for on-line generating a password protected and barcode prepaid instrument of entitlement and activating said instrument on presentation over a computer network

(76) Inventor: Khai Hee Kwan, Kingsford (AU)

Correspondence Address: KHAI HEE KWAN, UNIT 6, 78-80 HOUSTON RD, KINGSFORD, 2032, AU

(21) Appl. No.: 09/945,586

(22) Filed: Sep. 4, 2001

Related U.S. Application Data
(60) Provisional application No. 60/235,578, filed on Sep. 27, 2000.

(51) Int. Cl. G06F 17/60

(52) U.S. Cl. 705/51

(57) ABSTRACT

A computer system network over the internet to allow users to purchase and print instrument of entitlements for goods and services in one website such as a ticket. Users can pay using credit cards or internet bank transfer which is automated by the host computer and causes the account to be debited and prints the said instrument. Users are provided with the opportunity to protect their tickets using personal identification such as passwords to activate the tickets on presentation. The host computer informs the merchants of the issued ticket which will be presented at their premises. Merchants can authenticate the ticket holder by reading the bar codes printed using a bar code reader and by inputting the identification number of the ticket which is linked to a personal identification password over the computer network. The ticket expires in full once activated by this password at the point of exchange for goods or services.

### BACKGROUND OF THE INVENTION

1. Technical Field

The present invention relates generally to a system and method for generating a password protected and barcode prepaid instrument of entitlement or ticket by the user in exchange for obtaining goods or services and more importantly for evidencing the ownership by requiring the legal user to authenticate using a password to activate the instrument. The instrument is evidenced by printing it directly from user's printer connected to client terminal in communication with a host computer or stored digitally. The word ‘ticket’ in this invention is to include a bearer instrument or certificate of entitlement and is interchangeable to mean the same as ‘ticket’. The present invention also provides for notification to issuers or sellers and means to activate the instrument by requiring users to authenticate using their password linked to the instrument. Users' passwords are first solicited to create this instrument. The system also provides for “challenge” question when the user forgets the password and to retrieve the password and means to create new password. In addition, the system has an electronic exchange module where valid instrument can be resold with complete transfer of ownership including authorisation.

2. Description of the Related Art

The World Wide Web is the Internet's communication medium and information retrieval system. One of the technical advantages of the World Wide Web is the ease with which information may be posted, printed, checked, verified and retrieved by users who have on-line access. At the moment, most merchants who are selling or offering services on line do so using a payment facility such as credit card, which is billed directly and the goods are sent to the recipient. There is however certain industries such as hotel, airlines, and cinemas where it is not possible to deliver the services immediately as there is a time difference between wanting to enjoy the goods or services purchased. Taking the hotel industry as an example, users can only book on line with the hotel and pay a little administrative fee to secure their accommodation. Customers will not be able to secure their accommodation until such time when they actually check into the hotel. This exposes two types of risks where the hotel may lose income because the user did not turn up and from the user's point of view, the hotel “sold” the room before the user turnup. Similarly for airlines and cinemas since both industries have to maximise their returns according to actual users at departure time and opening time respectively.

Currently, some airlines are using the Internet to sell “electronic tickets” which is basically where the users pay for the ticket in advance using a credit card and to pick up the physical boarding pass at the airport. The “electronic” ticket is therefore stored with the airline's computer system with the user being offered an itinerary & receipt with a reference code as record that is usually sent by email or mail. This is not a true ticket or bearer instrument in the usual sense. While this method is useful, it only solves the problem partially since only the airlines may have reduced their exposure. The same is not for the users. One of the primary reasons is that users do not have a physical ticket at the time of purchase over the Internet even though they have a reference to such a purchase. Users may not be particularly enthusiastic about buying a ticket and receiving a confirmation number or receipt number to redeem for it at the airport. For instance, the confirmation number may have been lost or forgotten which may cause delay at the time of departure when airport staff tries to bring up details of the customer to authenticate the purchase. To fix this, airlines do provide the option of delivery the physical ticket to the user by courier or post if time permits, which add further cost to the ticket and delivery uncertainty to the user.

What is required is therefore for the user to automatically receive a bearer instrument at the time of purchase over the Internet. Without the features of this invention, from the issuer's point of view, the problem with generating such an instrument on line under the control of a user are security and forgery risks. Security relates to authenticating the ticket. Authenticating here refers to confirming the legal existence, ownership and entitlement of the instrument. Legal existence refers to the validity of the instrument, which can be checked against a reference to the online database. While one can still identify the user through presentation of identification papers, the reverse is not true in confirming entitlement. To be able to claim entitlement the instrument bearer must be the owner and no one else. As it is well known, identification papers can be easily forged and hence are not reliable. For example, how do we ascertain that this is the actual owner and not an impostor? Hence the invention discourages direct reselling and in particularly, scalping of tickets. If there is any reselling required, this invention also provides for a module to transfer the ownership completely and within the legal parameters of price controls when reselling tickets. The second is forgery of the bearer instrument itself. Without a tamper proof verification system, the issuer will be exposed to numerous forged instruments and the consequences. In addition to highly unique qualities, most physical bearer instruments have certain generated codes, which are pre-printed on them including bar codes, which are mathematically unique and machine-readable. Unique here does not guarantee that it cannot be a forgery and therefore it is just as important to authenticate ownership as well. Forgery here means someone able to obtain the unique codes and make a fake instrument for presentation to obtain services before the real owner or issuer realise this fraud. A typical example here is the driving license, which can be forged and used to obtain credit facility under the real owner's name. If a password is incorporated into the license and when presented requires this to prove ownership then it will be more difficult for the theft to occur.

If money can be counterfeited why can't any bearer instrument? In this invention, when a user purchases a printed bearer instrument on-line, a user password previously asked is linked to the instrument on creation. This password is required to activate or authenticate the ownership of the instrument hence satisfying both forgery and security challenges. While it is possible to ‘guess’ or ‘forge’ the unique generated code, it is that harder to accomplished the password requirement particularly at the time of validation. In this invention, the user has to be face to face to validate the bearer instrument at the issuer's venue. Equally important in addition to being able to view and print the instrument immediately, this system also sends an email containing the digital image of the instrument to the user's computer or mobile device over the net. Currently there is no password requirement for a bearer instrument and only supporting identity check is required for proof of entitlement. By way of its printable function, this invention also reduces the need for procurement of ready printed bearer instruments and since they are made on demand, reducing the risk of them being stolen or ‘misplaced’ from within the organisation.

In U.S. Pat. No. 5,761,648 by Golden, et al. named “Interactive marketing network and process using electronic certificates”, it details an electronic certificate profiling system consisting of redeemable coupons. In essence it requires user's data before the coupon is issued. There is no mention of printing in its claims nor further authentication of the ownership using a password as provided in the present invention. Furthermore a coupon works differently to a bearer instrument since payment by user is required. In U.S. Pat. No. 5,907,830 by Engel, et al. named “Electronic coupon distribution”, it details a method of printing a coupon with indicia and identification bar code on-line. In the latter said patent, client's data is encrypted in the bar code. The claims in the latter said patent did not include payment, which could only indicate that this is a “free” service for the coupon issuer, the same is not true with this invention. As quoted in said patent, “The coupon generally provides a discount for the product or service purchased by the consumer”. Similarly, both said patents relate to a coupon distribution system with different variations to capture client's profile for additional marketing purposes, the present invention is system and method to print a barcode and password protected bearer instrument with an authentication module, which serves different purposes than a coupon distribution system.

In U.S. Pat. No. 6,233,565 by Lewis, et al. named “Methods and apparatus for internet based financial transactions with evidence of payment”, the invention provides for a way to purchase a service with evidence of payment as in a printed receipt. This invention is mainly for the issuance of stamps on line and while it evidences payment in the form of receipt as printed at the client's printer, the mark difference in our submission includes authenticating the printed receipt with its owner or bearer by way of a password. This is the most important concern with bearer instrument with a prepaid value so that agreed services can be provided to the legitimate owner at the point of sale. In Lewis' patent, reading the unique barcode on the “receipt” authenticates the receipt with reference to the issuance server. In short while this is acceptable for a “stamp” like instrument, it is lacking for a bearer instrument having rights to receiving services or goods for its owner at the point of presentation as in our submission where the bearer need to be authenticated too. Authentication, in Lewis' patent is also limited to accessing the service while in this submission is to receive the services at the point of sale. Our invention provides evidence that the user has purchase a right to certain services or goods, which is not deliverable until they can verify their legitimacy and rights to the service.

### BRIEF SUMMARY OF THE INVENTION

According to the present invention, users wishing to purchase a ticket or instrument of entitlement for services or goods need only to go to the designated website of the merchant or issuer. The invention allows the user to purchase using a credit card or bank transfer on-line, receiving payment from user online, receiving a user's password linked to the number identification of the ticket and steps for printing the ticket or instrument to redeem for goods and services from the merchant or issuer. The host server which includes a database and programmable computer being networked to the Internet allow the user to do the usual selection of services remotely. The said computer also includes programmable steps for receiving from user a selected service or goods, check their availability and preparing for the printing of the ticket or instrument after payment has been received from user. The program also includes steps for requesting from the user a personal password and generating an identification number linked to this password without which the instrument shall not be activated on presentation to the merchant or issuer to consume the prepaid services/goods bought. This identification number will be the number for the ticket or instrument and will be printed on the instrument or ticket when instructed by the user. A bar code version or variation of this number under a pre-set formula is included and printed as well. The bar code number and the instrument's identification number may be the same number or a variation in accordance to a predetermined formula, say X+Y=100 where X is the bar code number and the Y is the ticket identification number. The user's password for a particular ticket is stored in the database and will expire at a pre-set expiry date if not activated before then. Upon payment verification, the host computer then provides the steps for remotely printing at the user's printer under user's control. If user does not have a printer at that time, user has the option to save the output to a digital image or file format for later printing. The actual ticket image is presented in a bit map format (BMP) or .gif or .jpeg which is created instantly and maybe embedded in the .html file for output on the user's screen and sent by email as an attachment. Depending on selection, the email may only contain an URL link to the page containing the .html file stored in the host computer with a predefined expiration time.

According to another embodiment of the invention, the user may connect to a “central” web site which offers goods and services from many merchants or issuers. While the mechanism is similar to a single merchant web site being linked to the Internet as above, there are some subtle differences. For one, the authentication method to activate the instrument, certificate or ticket is done from a remote merchant terminal connected to the central host server. In addition, this invention also provides for an activation device connected to the merchant's terminal or directly to the host computer via a modem connection through an Internet gateway, consisting in part a bar code reader, a resident program and a keypad to input the password. Each merchant will have an additional merchant code and password to access the remote server's database storing the encrypted user's passwords and instrument's ID. This additional feature is to segregate the different merchant accounts and provide security to identify the merchant. Merchants will also have their own administrative pages where they can view their transactions and to update their services or goods being offered on the host computer. Alternatively, merchants or issuer may wish to keep the availability of their goods and services separate in their own servers such that the availability query will be sent over the net to their servers. Secondly, merchants will be notified by email or electronic messaging once a purchase is done for their services or products. In a single merchant web site, no email is sent since all records are placed inside the database being accessed by the merchant owner. What is notable is that this invention relies heavily on the integrity of the Internet and hence security and encryption of data will be of primary concern. The framework for this invention requires at least one server or host computer with a database backend, a random number generator, a client's password and networked to the internet to give access to at least one user's terminal with printing capability and one merchant's terminal with at least a bar code reader or a ticket activation device.

According to another embodiment of the present invention, pluralities of clients' terminals are connected to the host computer through a network to purchase and print their instrument of entitlement such as ticket in this instance. A host of merchants' computers are connected to the host computer to activate the presented printed tickets or bearer instruments by submitting the passwords to the host computer over a network. Merchants' computers will verify merchant's login, read the bar code printed on the instrument to establish the identity, input the number or ID and lastly the user's password to activate the instrument.

According to another embodiment of the present invention, a method is disclosed for querying the availability of a service or goods, a fund transfer pre-approval and further verifying a second time the availability of a service or goods and if available, only then completes the transfer of the funds to the issuer. According to yet another embodiment of the present invention, a method is disclosed for controlling and printing of the instruments such as tickets remotely by the clients after payment for the tickets or bearer instrument have been approved and transferred to the service provider.

According to yet another embodiment of the present invention, a method is disclosed for requesting and accepting a password from the user wherein such password is linked to the identification of the instrument or ticket being purchased by the user. Such password is used to authenticate and activate such ticket or bearer instrument on presentation to issuer.

Preferably, the site earns a fee for each ticket or instrument that is accepted by a merchant or purchase by a user.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1 is a simplified illustration of a computer network system for multi-merchants in which the present invention may be implemented.

FIG. 2 is a simplified user interface illustrated a home page for the user to purchase a ticket of the present invention.

FIG. 3 is a representative user interface illustrated a page for the user to input credit cards details to be sent to a credit authority for approval inclusive of the required password.

FIG. 4 is a flow chart representation of the steps taken to validate a credit card and to secure the goods or services.

FIG. 5 is a representative of the printed ticket.

FIG. 6 is a flow chart representation of steps taken to activate a ticket on presentation at the merchant's premises.

FIG. 7 is an alternative block diagram for a single merchant network system in which the present invention may be implemented.

FIG. 8 shows a preferred ticket activation device.

### DETAILED DESCRIPTION OF THE PREFERRED EMBODIMENT

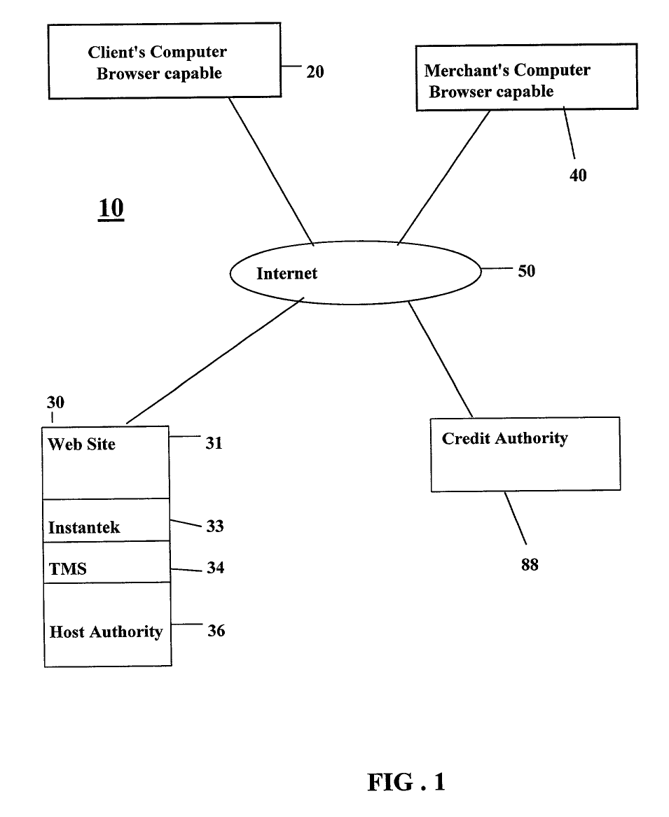

FIG. 1 is a block diagram of a computer network system 10 of the present invention. Computer system 10 comprises at least one client computer 20, preferably a computer workstation. Computer 20 is connected to a host server computer 30, at least one of merchant's computers 40 and at least one credit approving authority's computer server 88 over at least one computer network 50.

Computer 20 is a computer generally known in the field of computers. A host server computer 30 contains hardware and software adapted to communicate with other computers over a computer network and to make available computer files or software stored in the server computer or a storage device connected thereto such that they can be accessed by a person from another computer connected to the network.

Although one host computer server is adequate for the purpose of this invention, to achieve the benefit of redundancy, data security and distributed computing, more than one computer servers is preferred.

The computer system of the present invention operates as follows:

Computer 30 makes available a web page which is a program written in either PHP3 or in Active Server Pages (ASP) to process scripts on the server, which is accessible by users' computer 20 and 40 through computer network 50. This is where the main entry point is into the system. The user is asked to select the merchant, the ticket or instrument that is being purchased. An input box for email is required in order to sent a confirmation receipt. In more complex situation like airline bookings, the selection can be more detail including a multitude of flight schedules and cost.

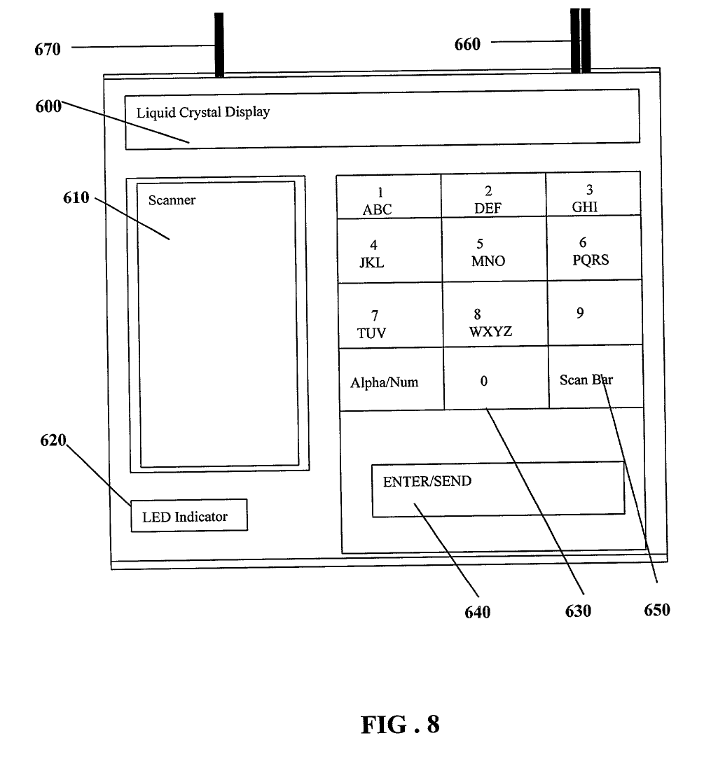

FIG. 1 depicts a preferred embodiment of a computer system 10 for purchasing a ticket and printing it on-line of the present invention. Computer network system 10 comprises a general purpose computer 30 as a server connected to computer network 50. Preferably, server computer 30 is a computer workstation, and computer network 50 is the Internet. More preferably, server computer 30 is connected to the Internet 50 via the fastest available connections. Computer 40 is a merchant terminal with an attached bar code reader and a database inventory of its goods and services connected to the Internet 50. An alternative activation device as in FIG. 8 maybe used.

Server computer 30 includes: (1) a World Wide Web site 31 such as www.instantek.com hosted by a web server such as Apache or IIS 5.0 (2) a computer software 33, designated herein as “instantek” for managing the “front-end” of the system such as receiving and accepting submission and generating the responses to the clients requests when they click through the website; (3) a computer software 34 called Ticket Management System (TMS) for managing the “back-end” of the system such as managing database with updates, deletion, administrative procedures, billings (4) Approving/Host Authority 36 a program that verify and activate tickets and payment. They are described in more detail below. All programs are accessible via their respective clients and are managed at the server side.

A. The Web Site

In the preferred embodiment, Web site 31 provides the following information or applications:

(1) A summary of current goods/service issuer and their status;

(2) Description of the types of facilities available;

(3) Description of the organization, designated herein as www.instantek.com, that runs the system and list of benefits and costs for using the instant ticketing system;

(4) Description of required legal disclosure for using the system;

B. Instantek 33

Residing on server computer 30, Instantek 33 is a client/server response/request application which is used to manage users activities. It is the front-end of the website and includes input forms for requests which are processed and pass-on to the back-end Ticket Management System 34 for action. An important function for Instantek 33 is the ability to query the chosen merchant's database for availability of a particular ticket at the time of request. However, given that not all users purchase immediately, this request is queried again at the time of submitting payment by host authority 36.

By design, it populates processed data from the database to be displayed to the users upon request. It then request the users to take further actions on this information such as providing instructional links, inputting a selection, updates, add new and so on. Instantek 33 also provides for client side checking of inputted data by users such as validating emails address, post codes and amount inputted, preferably using client side scripts. Provided instructions were passed from Host Authority 36 to Instantek 33, it will provide the output for the ticket to be printed. By itself, this program cannot execute backend functions but only facilitates them using commands such as “search”, “post” and “submit” for further action to Ticket Management System 34 since these data can only be processed at the backend.

C. Ticket Management System 34

Ticket Management system (TMS) is a client/server application residing on server computer 30. It operates to manage the client response/requests sent by Instantek 33 and from Host Authority 36. It hosts a database such as Oracle or MS SQL 7. TMS 34 is designed to be all purposed and can be adapted for as many database administrative functions as possible. It stores the many passwords associated to the issued tickets, merchant's logins and accounting for each transaction.

D. Host Authority 36 Host Authority functions as a “administrative” program where entries are considered and verified by the web site operator. Web site operator use this program to monitor activities and connections to the computer 30, 40, 88 and can manually disconnect users. Web site operator may also set time limits by using cookies for each session to purchase a ticket or upper monetary limits of purchase of each ticket. Host Authority 36 validates the merchant's login and the ticket activation sequence by checking it against stored data in database under TMS 34. It is also responsible for electronically submitting a potential purchase query to credit authority 88 for pre-approval. It queries the desired merchant's database for the availability of the goods and services immediately when the credit authority provides the pre-approval. It is only when the second query of availability is good then Host Authority 36 sends a confirmation purchase to the Credit Authority 88 to transfer funds to the merchant or issuer and electronically receive the response from the Credit Authority 88 at completion to ensure that funds are transferred. This two step credit approval and transfer (pre-approval and confirmation) is crucial since in ticket events, tickets are purchased at a rapid rate and what is available at the time of initial query by Instantek 33 may not be available at the time of purchase even though the time difference may only be a few minutes. A pre-approval session with the Credit Authority 88 is then useful since it “reserves” the amount while checking the ticket availability again. If there is no ticket at the second query, the “reserved” amount is released by sending an electronic instruction to Credit Authority 88. Host Authority 36 is also responsible for generating an unique identification number for the ticket issued and attached this number with the user's password. Host Authority will then instructs TMS 34 to store both values into the database, including other data unique to the purchaser in an encrypted format. Host Authority is also responsible for providing the steps and means to the user for printing the ticket on line including both unique identification number and bar codes such as the desired URL link and timed driver for the printing sequence. At completion, Host Authority will response by sending an email receipt to user and an email notification to the specific merchant that a ticket has been purchased. The email notification shall contain the unique identification of the ticket. If any of the procedures failed, Host Authority 36 will response to Instantek 33 the nature of the failure and record the error in Host Authority's 36 error log. Instantek 33 will depending on the nature of the failure response appropriately to the user. Failures can come in the form of no tickets are available for such event or credit card failure. Host Authority 36 provides a log of all the activities completed or otherwise by Instantek 33 and TMS 34.

Host Authority 36 is used to activate the ticket by validating both password and unique ticket number when submitted by merchant through instantek 33 from merchant's terminal over the network. This procedure requires the merchant to first log into Host Authority 36 from terminal 40. Once activated, the ticket is the “spent” and no longer available. Host Authority will instruct Ticket Management System 34 to update the ticket's status as closed in the database.

Host Authority 36 is also to provide a ‘resell’ module where existing ticket holders can offer to sell their valid ticket to others. Ticket holders are prompted to give reasons for this action. Host Authority 36 will first confirm the existence of the ticket and ticket seller/holder and only then publish on line the offer ticket within the price control parameters to satisfy legal requirements. A potential buyer over the network will then indicate interest to purchase the ticket and provided payment and a password are satisfactory, host authority will then delete the offered ticket by instructing TMS 34 and to update a new ticket to the purchaser and link this to the purchaser's password. TMS 34 will first delete the previous ticket and update this with information on the new ticket with the new purchaser's information and respond back to Host Authority 36. Host Authority 36 will complete the transaction by crediting the seller's account with the sale price less a fee and sent instructions to the purchaser to print the ‘new’ ticket. Host Authority 36 will then update the issuing merchant server on this particular transaction for record purposes and close connection to the purchaser.

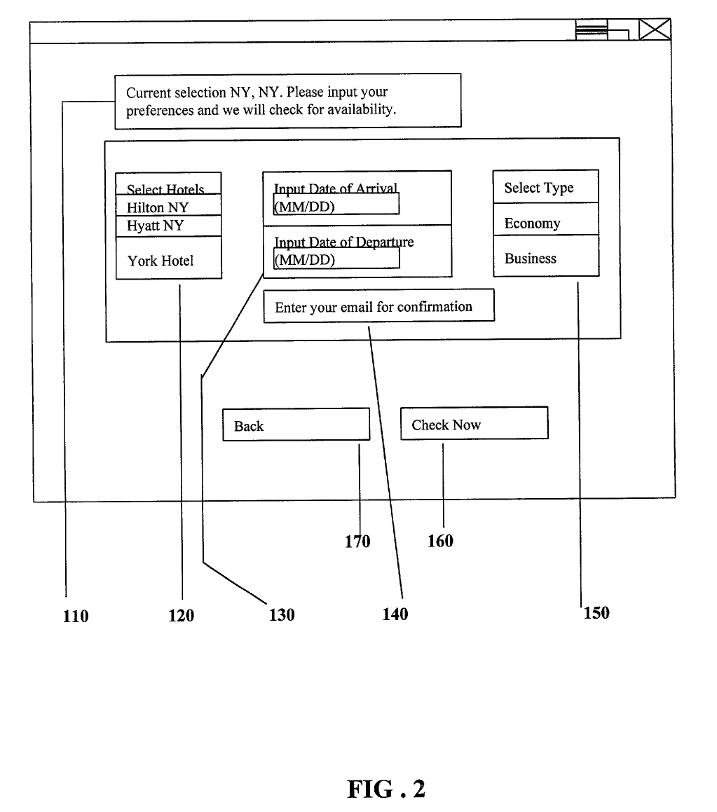

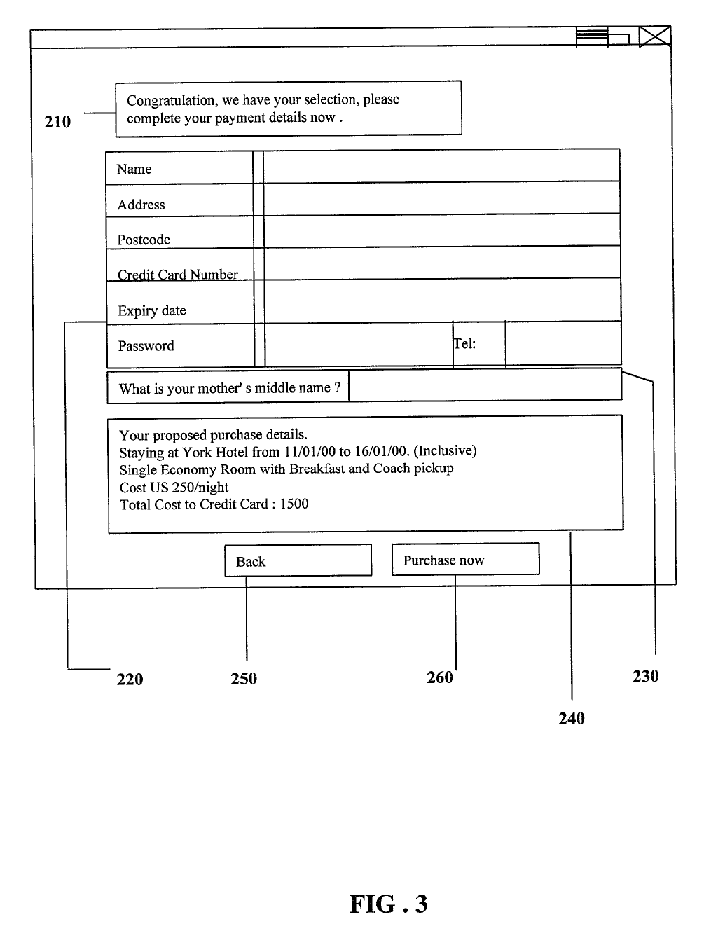

The computer programs as described above at the web site include appropriate display routines for generating a set of display screens that together comprise a user interface for the site. By going through these displays, one will be able to see the real functions of each program and their interactivities. FIGS. 2-3 are representative display screens, although the particular screen layouts should not be taken to limit the scope of the present invention.

FIG. 2 shows the web page for the user wanting to purchase a ticket for which in this case is accommodation in New York City, state of New York as shown in Box 110. It is noted that prior to this selection, the user was asked to provide certain criteria such as the city of choice and the average cost he is willing to spend. The search function in Instantek 33 will query TMS 34 which will produce this result as seen in FIG. 2. In Box 120, the user is presented with a selection of 3 hotels. In Box 130, the user is asked for the date of arrival and date of departure. In Box 150, user is asked for the particular accommodation type which in this case only both economy and business are available to these 3 hotels. Should the user have other requirements, he can use the back button 170 to improve his search. In Box 140, user is required to input a valid email address which will be verified by Instantek 33 on submission. The email address is important as it serves as a backup receipt including purchase details and access codes for this purchase as discuss later.

FIG. 3 is a simplified output page for user after submitting using button 160 in FIG. 2. The output of this page is dependent on 4 factors, the first being a legitimate email being verified by Instantek 33, the second being the availability of the selected hotel 120, the availability of the period of stay 130 and lastly the type of accommodation 150 chosen by the user earlier. This query is done on a real time basis on the merchant's availability database at terminal 40 over the network for a multi-merchant system or as the case may be the availability database may be stored in the host server 36. In a single merchant system this said database of availability is stored in the host server 36. If all this criteria is confirmed by instantek 33, a congratulation message is seen in box 210. This input page is stored in a secure server environment. In box 220, the user is required to input his personal details, credit card number, expiry date, phone number and a password. In box 230, a challenge question is presented to help the user in case the user forgets the password. In the event, the user forgets the password to activate the ticket, the challenge question will be presented. Once this challenge question is answered correctly and a legitimate email is presented, an electronic mail will be send to the email address the user previously provided containing the password.

In Box 240, the details inputted by the user in FIG. 2 are presented again for confirmation with the cost being calculated and the amount to be debited from the user's credit card shown. If the user agrees with all the information, user can press purchase button “now” at 260. Because the website 31 uses cookies to track user's movement in the site, a back button 250 is provided so that the data will be reset rather than stored in sessions. By not having a back-button, the data will be stored each time the user moves back and forth which may results in double counting in the total cost.

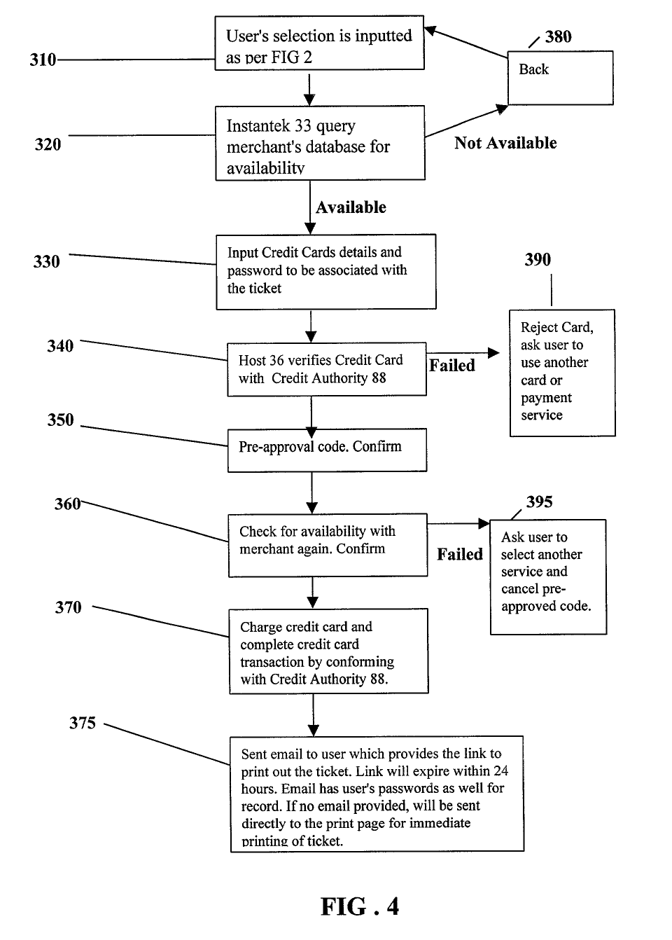

In FIG. 4, this is a flow chart showing the events from FIG. 2 and FIG. 3 to confirmation of purchase. In Box 310, the user's selection is inputted as per FIG. 2. In Box 320, the inputted details are query on merchant's availability database. In Box 380, the user is brought back to the selection page again if the selections are not available. If all the conditions are satisfied, it proceeds to Box 330 which is basically FIG. 3 where details of payment instrument such as a credit card or as the case maybe bank transfer is sought (not shown here) including password and a challenge question like user's mom's name. This challenge question may be selected from other choices to suit the user's needs. A more popular choice maybe the user's date of birth which is not shown in FIG. 3. In Box 340, Host Authority 36 verifies the credit card details with Credit Authority 88 over the network using secured connections. Credit Authority 88 in this case can be a bank or a payment gateway. In Box 360, if the card is “good”, Host Authority 36 will ask for a pre-approval code to reserve the amount to be debited and immediately query with the Merchant or issuer again to confirm availability of the conditions previously requested by the user. If this is still good, then Host Authority will instruct Merchant's computer to lock in the purchase by confirming the details. Host Authority 36 will instruct the Credit Authority 88 to debit the amount to complete the transfer of funds and to receive from Credit Authority 88 the transaction code which will be stored by TMS 34. This transaction code is forwarded to Merchant's computer 40 as a receipt number record. Host Authority 36 will send a notification to user in Box 375 with the details of a hyperlink where the user can print out the ticket. This hyperlink will often expire by itself within 24 hours. This notification, which is usually by email will also contain user's password and purchase details such as the transaction code. Alternatively, the user may be brought into a page with the image of the ticket for printing instead of sending an email. Both methods are programmable depending on user's requirements or the case may be both methods are applied. It is noted that all 4 parties (user, merchant, host authority, credit authority) have this transaction code which is the main reference code for this purchase. However this is not the code to activate the ticket, it is merely a receipt number for the transaction. In box 390, the presented card is rejected and another payment instrument is required which means going back to FIG. 3 input page. In box 395, the conditions required by user are not available anymore so user need to select other conditions which means going back to FIG. 2 input page. This is similar to box 380.

It is noted that user has also limited time to complete this printing of the ticket. In most cases, the user will be prompted to print as soon as the ticket image embedded in the html page is fully downloaded and shown on the screen monitor. If no action is taken, Instantek 33 will detect if there is a printer connected to the user's terminal. Provided there is one, it will automatically print the ticket file. Instantek 33 will then close its connection to the user's terminal.

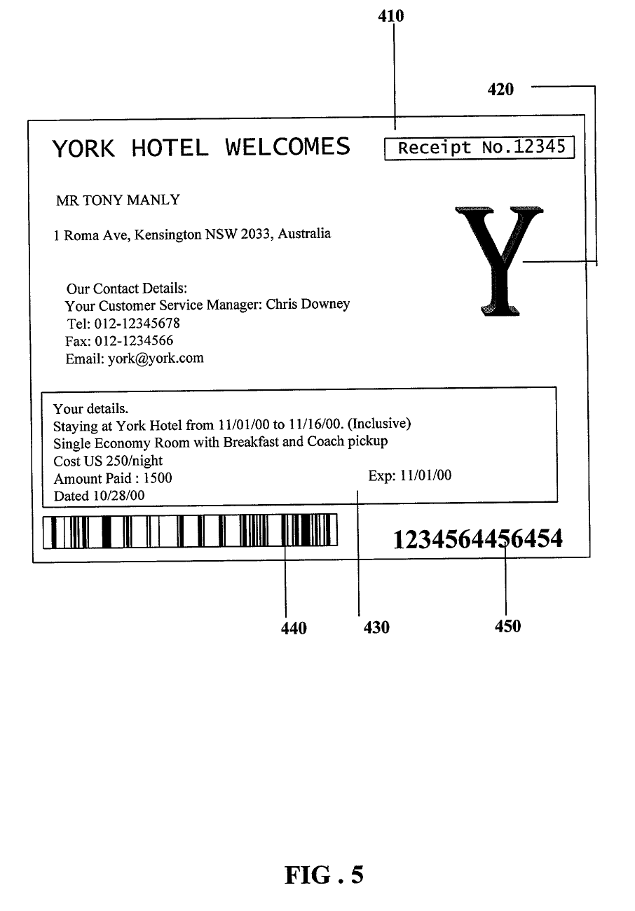

In FIG. 5, this is a sample of a ticket output ready for activation. The user need only to bring this “ticket” to York Hotel for activation to get his services as ordered. In Box 410, this shows the receipt number for this purchase through the user's credit card. In Box 420, we have the logo of the merchant or issuer providing the service. This logo may have different colours or shade or characteristic to reflect certain pre-set conditions so to provide a cursory inspection, which is only noticeable by the merchant's trained staff.

Alternatively not shown here, specially develop “customised” fonts may be used to print the words on the ticket, all of which is easily recognisable by the trained eyes. Given the international focus of the Internet other fonts in various languages are included. In Box 430, we have the details of the purchase including the expiry date, which means if the ticket is presented after this date it will be void. In box 440, we see the representation of a number in a bar code format and the corresponding number 450 generated by Host Authority 36. The bar code together with the number and user's password is required to activate this ticket before its expiry on the Nov. 1, 2000. Preferably, a copy of the purchase or reference to the purchase agreement or words to the effect that this ticket is not transferable and void if transferred is included (not shown here) and printed at the bottom section of the ticket.

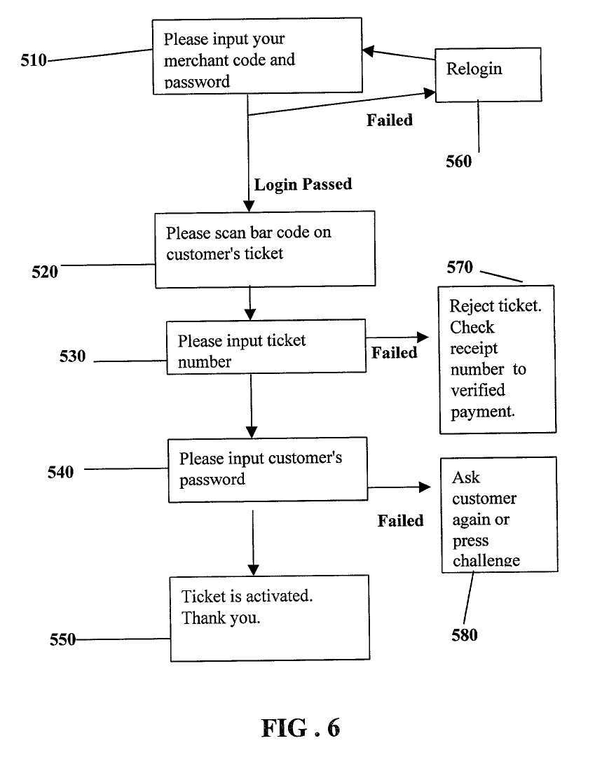

FIG. 6 shows the steps required for the merchant to follow to activate the ticket when presented by the user at the merchant's premises. Box 510 shows the requirements on the merchant's browser once connected to web site www.instantek.com 31. In the actual screen two input boxes will be shown one for merchant code and one for password. This is not shown here. Once submitted and merchant is verified, the next step will be to scan in the bar code as shown on the ticket 520. In the prefer embodiment, merchant's terminal 40 has a bar code reader to enable this task of reading the bar code 440. Once this is done, the next step is to input the number 450 by the merchant. The bar code information is decoded using a decoder software resident to terminal 40 and is compared to the number 450. Different versions of this resident program may be downloaded from Host Server 36 as instructed from time to time by Host Server 36. On comparison, if both are similar or verifiable by a pre-determined formula then customer's password is required 540. Password from user can be obtained by asking the user directly or verbally or by asking user to type into the terminal's key board. Alternatively, the case maybe transmitted using wireless communication devices like a mobile phone or palm pilot connected to an Internet gateway. Preferably both devices are Wireless Application Protocol (WAP) enabled. The latter option includes connecting to the website 31 to reach Host Authority 36. Once authentication is completed say using a mobile phone where the originating mobile phone's number will be checked against the record presented earlier by the user stored in the database, user password's verification is required before it can be activated. In another embodiment, a ticket activation device may be used in lieu as shown in FIG. 8. Activation, is done by sending the number and the password obtained from the user to the Host Authority 36 where it will check both inputs against the database record in TMS 34 over the computer network. At Box 550, if both exist, then the ticket is activated in the merchant's account in TMS 34. An “activated” reply will appear in merchant's terminal. If the password is incorrect, the merchant is informed at 580 and ask to input again up to 3 times. Then a challenge question is asked and if this is correct, the password will be sent to the user's email address given previously. If all fails, the merchant has the option to check the purchase order in the form of the receipt number against its own records to see if this is valid. Since no more than 4 different parties know this receipt number, Instantek cannot take responsibility if it turns out to be applied fraudulently. Hence merchant should avoid using this and it is quite obvious, barring machine error, if a user cannot remember his own date of birth or mother's name to signal that this may be a problematic account. Hence precaution should be raised rather than lowered. Once activation is completed, TMS 34 will then update the ticket as “spent” and both number and password will be deleted from its database.

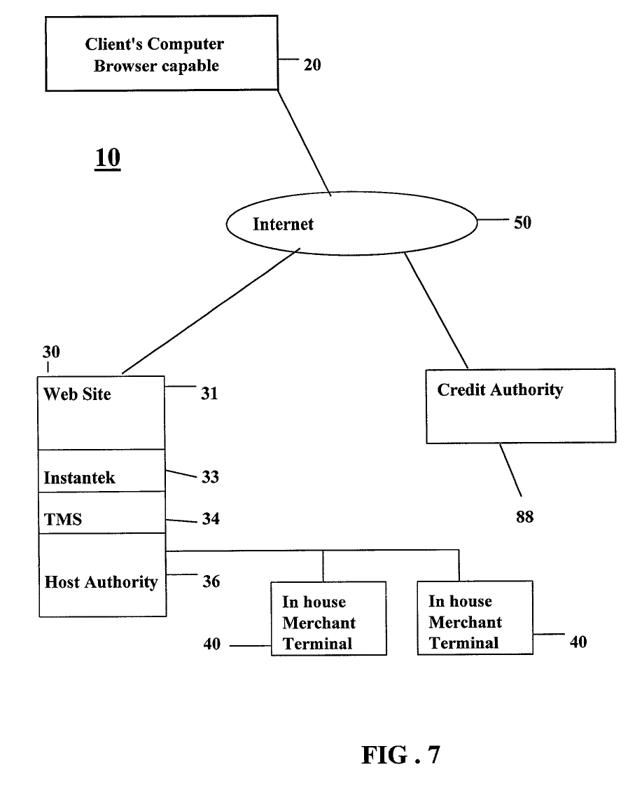

FIG. 7 represents a block diagram for a single merchant network where the main difference is that the merchant's terminal are connected directly to host authority 36 within a LAN inside the merchant's premises. Given this system is simple and easily configurable, merchants would prefer having their own network than to share with other merchants considering the safety and security aspects. However, in doing so, merchants must also recognise the cost of maintaining and running such a system after it has been set-up.

FIG. 8 shows the ticket activation device in lieu of the bar code reader and keyboard. In effect the device is a combination of both installed together in a casing to enable issuers to have ease of access with as a little computing knowledge as possible. The device can be connected at 670 to the Internet by using a modem card built inside or connected through a communication port in terminal 40 either way to enable it to communicate with host computer. In a preferred embodiment, the device would have incorporated the merchant's ID. Merchant start the process by pressing scan bar button 650 which activates the scanning process. The ticket's side with the bar codes are placed near the surface of 610 and in the scanning process, the staff member would move the ticket across the exposed reader's surface slowly. The led indicator 620 will show a red light for a bad scan and a green light for a good scan. Liquid crystal display 600 will show the result like “scanning”, “scan again”, “done” and provides other instructions as well like “input ticket number now” or “ticket is activated”, or “ticket failed” or “please input password” etc. At 630, is the alpha/numeric keypad use to input the electrical signals representing the codes and 640 is pressed to sent them for processing. The device would have a small central processing unit, a resident program and random access memory to provide the results above. 660 shows the connection to the power source for the device.

Overall, the inventive mechanism is preferably implemented within at least one server over one network. Thus, the invention does not require any modifications to conventional client machine hardware or software. Although not meant to be limiting, the above-described functionality is preferably implemented as standalone native code or, alternatively, such as a Java servlet. Generalizing, the above-described functionality is implemented in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network.

In addition, although the various methods described are conveniently implemented in a host server computer selectively activated or reconfigured by software, one of ordinary skill in the art would also recognize that such methods may be carried out in hardware, in firmware, or in more specialized apparatus constructed to perform the required method steps.

Further, as used herein, a Web “client” should be broadly construed to mean any computer or component thereof directly or indirectly connected or connectable in any known or later-developed manner to a computer network, such as the Internet or wireless Internet. The term Web “server” should also be broadly construed to mean a computer, computer platform, an adjunct to a computer or platform, or any component thereof capable of being a server in the ordinary meaning of the technical reference.

The term “instrument of entitlement” is use generically and should be broadly

read to encompass any type business that may issue tickets on line for activation later on presentation including bearer instruments where ownership must be ascertained. Examples of such business would be airline tickets, sports tickets, event tickets, hotel tickets as exemplified here. However it could include security documents such as land title deeds issued by the local council where it represents ownership and proof of title rather than merely proof of purchase as in a document identity number. Bearer bonds or even in a driver's license as a way to protect the ownership and to allow the issuer to save cost be issuing online. It is not difficult to see that in the near future, drivers will be able to renew their license by using the web and this invention. The term “issuer” is use generically and should be broadly read to encompass issuer, vendor, merchant or seller.

Having thus described our invention, what we claim as new and desire to secure by Letters Patent is set forth in the following claims.

While the present invention has been described above in terms of specific embodiments, it is to be understood that the invention is not limited to the disclosed embodiments. On the contrary, the present invention is intended for various modifications and equivalent structures included within the spirit and scope of the appended claims.

I, the inventor claims:

1. A computer network method for printing, under user control, from a computer network system, a password protected and barcode instrument of entitlement including generating a digital format to be used for obtaining goods or services from a merchant, wherein said computer network system includes at least a host server, a client terminal, a printer, a merchant server, a mobile communication device, a credit authority server as well as interface means, means for verifying availability of goods or services requested, means for payment, means for receiving pre-approval and final approval for such payment from said credit authority, means to transfer funds from user to merchant's account controlled over said computer network, said instrument including a plurality of sections and formats, said method comprising the steps of:
requesting for a user's password to create the instrument through said user interface means;
requesting for a user's mobile communication device number to sent the digital instrument receipt through said user interface means;
providing the name of a merchant of goods and services and a monetary value for the instrument through said user interface means;
printing within one section of said password protected and barcode instrument, the name of the merchant, the monetary value of the instrument, receipt number, the bar code and associated identification number of the instrument; and
printing within another section of said ticket, the nature of the service or goods, the name of the instrument holder, the expiry date of the instrument and graphics representative of the merchant's indicia on client's printer over said computer network.

2. The method according to claim 1 wherein the method further comprises: providing the name and details of an intended recipient; and printing within said one section the name and details of the intended recipient on client's printer over said computer network.

3. The method according to claim 1 wherein the method further comprises causing said computer network system and in particular the host server to identify said instrument with an identification number and associated barcodes printed on another section of said instrument in accordance to a pre-set formula known only to the host server.

4. The method according to claim 1 wherein the method further comprises causing the host server to request the user for a password to be linked to the said instrument identification number without which the instrument shall not be activated over said computer network where such password and said instrument identification number are encrypted and stored in a database within the host server.

5. The method in accordance to claim 1 include step of notifying said issuer and purchaser of the instrument issued with said issuer's name on it, the instrument receipt number, the amount, user's details, the type of service or goods or entitlement paid for this particular instrument over said computer network to merchant's server and purchaser's mobile communication device.

6. The method according to claim 1 wherein said paying step includes pre-approving the transfer, checking the availability of services or goods with issuer's availability database and if satisfactory, complete the paying step by transferring the funds to issuer's account over said computer network.

7. The method according to claim 1 wherein step include said issuer shall authenticate the presented instrument of entitlement by using a bar code reader to read the bar codes printed on the instrument and matching this result against the instrument identification number in accordance to a pre-set formula known only to the host server over said computer network.

8. The method according to claim 1 wherein step include said merchant shall authenticate the presented digital instrument of entitlement by causing to download the digital instrument from the user's mobile communication device and matching this data against the stored data in accordance to a pre-set formula known only to the host server over said computer network.

9. The method according to claim 1 where upon authenticating the instrument of entitlement, the method further comprises the step of said issuer activating the instrument by verifying the password presented by user against the user's password stored in the host server's database which is unique to each instrument issued by the host computer over the said computer network.

10. A computer network system for printing, under user control, a password protected and bar code instrument of entitlement including generating a digital format to be used for obtaining goods or services or entitlement from an issuer, wherein said computer network system includes at least a host server, a client terminal, a merchant server, a printer, a mobile communication device, a credit authority server as well as interface means, means for verifying availability of goods or services requested, means for payment, means for receiving pre-approval and final approval for such payment from said credit authority, means to transfer funds from user to merchant's account controlled over said computer network, said instrument including a plurality of sections and formats, said system comprising the means to:
request for a user's password to create the instrument of entitlement through said user interface means;
request for a user's mobile communication device number to sent the digital instrument through said user interface means;
provide the name of an issuer of goods and services and a monetary value for the instrument through said user interface means;
print within one section of said password protected and barcode instrument, the name of the issuer, the monetary value of the instrument, receipt number of the instrument, the bar code and associated identification number of the instrument; and print within another section of said instrument, the nature of the service or goods, the name of the user, the expiry date of the instrument and graphics representative of the issuer's indicia on client's printer over said computer network.

11. The system according to claim 10 wherein the system further comprises means to provide the name and details of an intended recipient; and printing within said one section the name and details of the intended recipient on client's printer over said computer network.

12. The system according to claim 10 wherein the system further comprises means for the host server to identify said instrument with a identification number and associated bar code printed on another section of said instrument in accordance to a pre-set formula known only to the host server.

13. The system according to claim 10 wherein the system further comprises means for the host server to request the user for a password to be linked to the said instrument identification number without which the instrument shall not be activated on presentation over said computer network where such password and said instrument identification number are encrypted and stored in a database within the host server.

14. The system in accordance to claim 10 further means for notifying said merchant and purchaser of the instrument issued with said issuer's name on it, the instrument receipt number, the amount, user's details, the type of service or goods paid for this particular instrument over said computer network to issuer's server and purchaser's mobile device respectively.

15. The system according to claim 10 wherein said payment means includes pre-approving the transfer, checking the availability of services or goods or entitlement with issuer's availability database and if satisfactory, complete the paying step by transferring the funds to issuer's account over said computer network.

16. The system according to claim 10 wherein means for issuer to authenticate the presented instrument by using a bar code reader to read the bar codes printed on the ticket and matching this result in accordance to a pre-set formula known only to the host server over said computer network.

17. The system according to claim 10 wherein means for issuer to authenticate the presented digital instrument by causing to download the digital receipt from the user's mobile communication device and matching this data against the stored data in accordance to a pre-set formula known only to the host server over said computer network.

18. The system according to claim 10 where upon authentication of the presented instrument, the system further comprises the means for said issuer activating the instrument by verifying the password presented by user or recipient against the user's password stored in the host server's database which is unique to each instrument by the host computer over the said computer network.

19. A method of authentication from a mobile phone or wireless communication device connected to a public switched telephone network, a bar code and password protected instrument for obtaining goods or services or entitlement from a merchant, wherein said method comprising the steps of:
requiring the merchant to input merchant's login into merchant's terminal using the key board to connect to the host server over the network;
scanning the bar codes on the instrument of entitlement using a bar code scanner device;
inputting the identification number on the ticket using the key board at the merchant's terminal;
response from the host server requesting the user to connect to a particular number from the user's mobile phone to the host computer connected to an internet gateway via the public switched telephone network;
upon answering the call, the host computer will capture and record the originating mobile telephone number in order to query the database as to the validity of the said phone and phone number;
receiving response from the host server that the mobile phone number is authenticated to a current live request for authentication from a merchant over the computer network;
requesting from the user for the password associated with the presented instrument;
user input the password by pressing on appropriate keys on the alpha-numeric pad on the mobile phone and sending it over the public switched telephone network to host server through an internet gateway;
querying the host server's database as the validity of the password in connection to the live authenticating request from the merchant for a particular instrument of entitlement over the computer network;
receiving a response from the host server as to the validity of the password over the computer network;
receiving a response from the host server to merchant's terminal as to the authenticity of the instrument and validity of its holder and terminate all connections.

20. A method of authentication from a mobile phone or wireless communication device connected to a public switched telephone network, a digital bar code and password protected instrument for obtaining goods or services or entitlement from a merchant, wherein said method comprising the steps of:
at the time of approving the purchase, host server notifying the purchaser of the purchase by sending a digital encrypted receipt to the buyer's mobile phone or communication device to be stored until presentment;
at the time of authentication, requiring the merchant to input merchant's login into merchant's terminal using the key board to connect to the host server over the network;
response from the host server requesting the user to interface the mobile phone to the merchant's terminal linking to the host computer connected to an internet gateway via the public switched telephone network;
upon interfacing to a data receiving socket at merchant's terminal connected to the host computer, the mobile phone will download the digital receipt received earlier sent by the host computer which will be sent to be matched against the original receipt stored in the host computer;
receiving response from the host server that the receipt is good or bad over the computer network;
requesting from the holder for the password associated with the presented digital instrument;
user input the password by pressing on appropriate keys on the merchant's terminal keyboard;
querying the host server's database as the validity of the password in connection to the live authenticating request from the merchant for a particular digital instrument over the computer network;
receiving a response from the host server as to the validity of the password over the computer network;
receiving a response from the host server to merchant's terminal as to the authenticity of the digital instrument and validity of its holder and terminate all connections.

21. A method according to claim 1 wherein the method further comprises steps for the host server to electronically completing a resell transaction of a password protected and bar code instrument between a remote prospective buyer and a remote potential seller, comprising:
electronically receiving from said seller an offer to sell containing at least one condition, the instrument number, and authorisation code such as the password over the network;
receiving name data representing an identity of said seller over the network;
verifying the authenticity and validity of the instrument's number, instrument's event and expiration, authorisation code of the instrument and identity of seller over the network;
storing said name data and instrument number to associate said identity of said seller with said instrument over the network;
electronically making available said sale offer to a plurality of remote potential buyers over the network;
electronically receiving from at least one of said remote potential buyer an unconditional acceptance of said sale offer;
electronically receiving name data from the buyer over the network;
electronically receiving from the buyer an authorisation to charge his credit card for the purchase and to credit the amount less a fee to the seller's account;
electronically sending said authorisation to credit card authorisation authority of the said buyer;
electronically receiving from the credit authorisation authority that the payment has been made for the purchase;
electronically receiving authorisation code such as a password from the buyer to be linked to the reissue instrument over the network;
electronically deleting the instrument number, authorisation data and name data belonging to the seller from the database;
electronically transmitting the reissued password protected and bar code instrument associated to said new buyer over the network;
electronically printing the reissued password protected and barcode instrument at the designated printer of said buyer over the network;
electronically storing name data, instrument number and authorisation code associated with the buyer in a database;
electronically notifying merchant server of the deletion of the previous instrument number and existence of the new reissued instrument number for recording purposes;
electronically transmitting a digital receipt to the merchant's server; and
electronically transmitting a digital receipt to the buyer's mobile device.

22. A computer network system according to claim 10 wherein the system further comprises means for the host server to electronically completing a resell transaction of a password protected and bar code instrument between a remote prospective buyer and a remote potential seller, comprising
means to electronically receive from said seller an offer to sell containing at least one condition, the instrument number, and authorisation code such as the password over the network;
means to receiving name data representing an identity of said seller over the network;
means to verify the authenticity and validity of the instrument's number, instrument's event and expiration, authorisation code of the instrument and identity of seller over the network;
means to store said name data and instrument number to associate said identity of said seller with said instrument over the network;
means to electronically making available said sale offer to a plurality of remote potential buyers over the network;
means to electronically receiving from at least one of said remote potential buyer an unconditional acceptance of said sale offer;
means to electronically receiving name data from the buyer over the network;
means to electronically receiving from the buyer an authorisation to charge his credit card for the purchase and to credit the amount less a fee to the seller's account;
means to electronically sending the authorisation to the credit card authorisation authority of the said buyer;
means to electronically receiving from the credit authorisation authority that the payment has been made for the purchase;
means to electronically receive authorisation code such as a password from the buyer to be linked to the reissue instrument over the network;
means to electronically deleting the instrument number, authorisation data and name data belonging to the seller from the database;
means to electronically transmitting the reissued password protected and bar code instrument associated to said buyer over the network;
means to electronically printing the reissued password protected and bar code instrument at the designated printer of said buyer over the network;
means to electronically storing name data, instrument number and authorisation code associated with the buyer in a database;
means to electronically notifying merchant server of the deletion of the previous instrument number and existence of the reissued instrument number for recording purposes;
means to electronically transmitting a digital receipt to the merchant's server; and
means to electronically transmitting a digital receipt to the buyer's mobile device.
